(19) United States
(12) Patent Application Publication
(10) Pub. No.: US 2024/0227972 A1
(43) Pub. Date: Jul. 11, 2024

(54) BICYCLE FRAME

(71) Applicant: MAHLE International GmbH, Stuttgart (DE)

(72) Inventors: Daniel Lobos, Valladolid (ES); Yaroslav Rakhnenko, Palencia (ES); Alberto Jesús Rico Sanz, Valladolid (ES)

(21) Appl. No.: 18/540,846

(22) Filed: Dec. 14, 2023

(30) Foreign Application Priority Data
Dec. 15, 2022 (EP) 22213818.2

(51) Int. Cl. B62K 19/30; B62J 45/20; B62J 45/414; B62K 3/02

(52) U.S. Cl. CPC B62K 19/30; B62J 45/20; B62J 45/414; B62K 3/02

(57) ABSTRACT

A bicycle frame is disclosed. The bicycle frame includes a plurality of tubular sections and a control unit arranged at least partly within one of the tubular sections. The control unit includes a housing that is rigidly attached to the tubular section. An accelerometer is arranged within the housing and arranged to sense an acceleration of the tubular section containing the control unit in an area of the control unit. The control unit includes a memory storing a tap recognition algorithm and a processor for analyzing an output signal of the accelerometer using the tap recognition algorithm to determine a tap action.

### CROSS-REFERENCE TO RELATED APPLICATION

This application claims priority to European Application No. EP 22213818.2 filed Dec. 15, 2022, the contents of which are hereby incorporated by reference in its entirety.

### TECHNICAL FIELD

The invention relates to a bicycle frame. The invention furthermore relates to a method for controlling or operating an electrically controlled bicycle component and to the use of a bicycle frame or a bicycle handlebar or a bicycle pedal of a bicycle as a tap input surface for controlling or operating an electrically controlled bicycle component.

### BACKGROUND

Bicycles can be provided with means for controlling/operating an electrically controlled bicycle component. A typical known prior art device for controlling/operating an electrically controlled bicycle component is described in EP 1375325 A2. This describes a switch which is mounted on the handlebar of a bicycle. The switch comprises a button portion for manually toggling between different switch positions.

### SUMMARY

The bicycle frame according to the invention has the advantage that electrically controlled bicycle components can be controlled without providing a manually operated device attached to the bicycle handlebar.

This object is achieved according to a first aspect of the invention with a bicycle frame for supporting a front wheel and a rear wheel, the frame comprising a plurality of tubular sections, a control unit arranged at least partly in one of the tubular sections, wherein the control unit comprises a housing, which is rigidly attached to the tubular section, wherein atleast one accelerometer is arranged within the control unit housing and arranged to sense an acceleration of the tubular section containing the control unit in the area of the control unit, and further comprising a memory storing a tap recognition algorithm and a processor for analyzing an output signal of the at least one accelerometer using the tap recognition algorithm in order to determine a tap action.

A bicycle frame according to the invention can used for a human powered bicycle or a human powered bicycle with electric motor assist, otherwise known as pedelec.

By using the accelerometer in the control unit within the bicycle frame, the frame itself can be used as the input device for controlling various aspects of the bicycle. A separate input device with cables connected to a control unit is not required, instead the operator can tap on the bicycle frame, e.g. in the vicinity of the control unit, and the acceleration of the control unit containing the accelerometer will be substantially the same as the acceleration of the frame in the vicinity of the control unit due to the rigid attachment of the frame with the control unit housing. A separate input device can thus be omitted reducing component costs. The operator of the bicycle does not need to locate a manual switch and can tap the frame whilst looking at the road ahead. The tap recognition algorithm can be configured to differentiate between a plurality of different predetermined tap actions, wherein the control unit is configured to output a signal for controlling or operating an electrically controlled bicycle component based on the determined tap action. In particular, the tap recognition algorithm can be configured to differentiate between a tap on the left side of the tubular section and a tap on the right side of the tubular section. The left and right sides being defined with respect to a forward travelling direction of the bicycle. A tap on the left side of the frame tubular section can be used for example to reduce the assist level of a motor provided on the bicycle to assist the pedal power, and a tap on the right side of the frame can be used to increase the assist level of the motor. Alternatively or additionally, the tap algorithm can be configured to differentiate between a tap on top side of the tubular section and a tap on the lateral side (i.e. left or right side) of the tubular section. A tap on the top side of the frame can therefore be used e.g. to turn a front or rear light on or off or alternatively block/unblock the bicycle suspension.

The different sides of the tubular frame section, in particular the top, left side and right side, can therefore be used as tapping input surfaces to operate or control a plurality of different electrically controlled bicycle components.

The different tap actions can also be in the form of a single or double tap, whereby the singletap action is determined by calculating the gradient of the acceleration between two consecutive acceleration samples, such that if the gradient exceeds a predetermined threshold a single tap action is determined, and wherein a double tap action is determined when two consecutive single tap actions are determined within a predetermined time window.

The tap recognition algorithm can be defined by machine learning.

In a further aspect a bicycle is provided having a frame according to the invention described above.

The bicycle comprises pedals and a handlebar for steering the bicycle, the handlebar being pivotally attached to the frame. In a further embodiment of the invention the handlebar can be used as an additional or alternative tap input surface. Although the handlebar is pivotally attached to the bicycle frame, a tap on specific parts of the handlebar can result in a translation motion of the handlebar, which can be transferred through the pivotal attachment to the frame.

The tap recognition algorithm can be configured to differentiate between a tap on the left side of the tubular section, a tap on the right side of the tubular section and/or a tap on bicycle handlebar.

The different sides of the tubular frame section, in particular the top side, left side and right side, and the handlebar can therefore be used as tapping input surfaces to operate or control a plurality of different electrically controlled bicycle components.

The bicycle can be a motor assisted bicycle comprising an electric motor and a battery can be arranged inside a tubular frame section and connected to the control unit, wherein the control unit determines the power supplied to the electric motor.

In an advantageous embodiment the at least one accelerometer in the control unit can also be used to provide a speed calculation algorithm stored in the control unit with acceleration data for calculating a speed of the bicycle.

In a preferred embodiment the control unit is arranged at least partly in the top tube of the bicycle frame. The control unit can therefore be easily connected via a cable in the bicycle frame to a battery in the down tube. The control unit can further include a display for displaying information to the rider. The display can for example be an LED display for displaying the charge level of a battery of the bicycle.

In a further embodiment a tap action can be in the form of a specific combination of different taps. For example, a specific combination of taps can be defined from at least two different taps of the following taps: a single left tap, a single right tap, a single top tap, a double left tap, a double right tap, a double top tap. This combination is then recognized by the tap recognition algorithm as a specific tap action, which can then be used for controlling an electric component of the bicycle. The electrical component can be the battery arranged in the bicycle frame such that power from the battery can only be supplied to an electric motor after a specific unlocking combination of taps is performed.

The frame tap input can also be complimented by a second input device attached to the handlebar of the bicycle for controlling or operating the same electrically controlled bicycle component which is controlled based on the determined tap action. In this case the use of the frame as an input device provides redundancy.

In another aspect a method for controlling or operating an electrically controlled bicycle component is provided, the method comprising providing a bicycle frame for supporting a front wheel and a rear wheel, the frame comprising a plurality of tubular sections wherein a control unit is arranged at least partly in one of the tubular sections, wherein the control unit comprises a housing, which is rigidly attached to the tubular section, and the housing contains at least one accelerometer, the method further comprising sensing via the accelerometer an acceleration of the tubular section containing the control unit in the area of the control unit, supplying an output signal of the at least one accelerometer to a processor, and using a tap recognition algorithm to determine a tap action and controlling or operating an electrically controlled bicycle component based on the determined tap action. The method can include using the tap recognition algorithm to differentiate between a plurality of different tap actions according to the invention as described above.

The tap action can be a tap on a part of a tubular section of the frame or a tap on the handlebar of a bicycle comprising such a frame.

In a further aspect, the use of a bicycle frame or a bicycle handlebar or bicycle pedals of a bicycle as a tap input surface for controlling or operating an electrically controlled bicycle component is provided, whereby the bicycle frame comprises a plurality of tubular sections, and a control unit is arranged at least partly in one of the tubular sections, preferably a top tube, wherein the control unit comprises a housing, which is rigidly attached to the tubular section, wherein at least one accelerometer is arranged within the control unit housing and arranged to sense an acceleration of the tubular section containing the control unit in the area of the control unit, the acceleration due to a tap on the tap input surface, and the control unit further comprising a memory storing a tap recognition algorithm and a processor for analyzing an output signal of the at least one accelerometer using the tap recognition algorithm in order to determine a tap action from a selection of predetermined tap actions.

### BRIEF DESCRIPTION OF THE DRAWINGS

Embodiments will now be described by way of example only with reference to the accompanying drawings, in which:

FIG. 1 is a side view of a bicycle according to the invention,

FIG. 2 is a top perspective view of part of the bicycle according to the invention,

FIG. 3 is a perspective view of part of the bicycle according to the invention.

### DETAILED DESCRIPTION

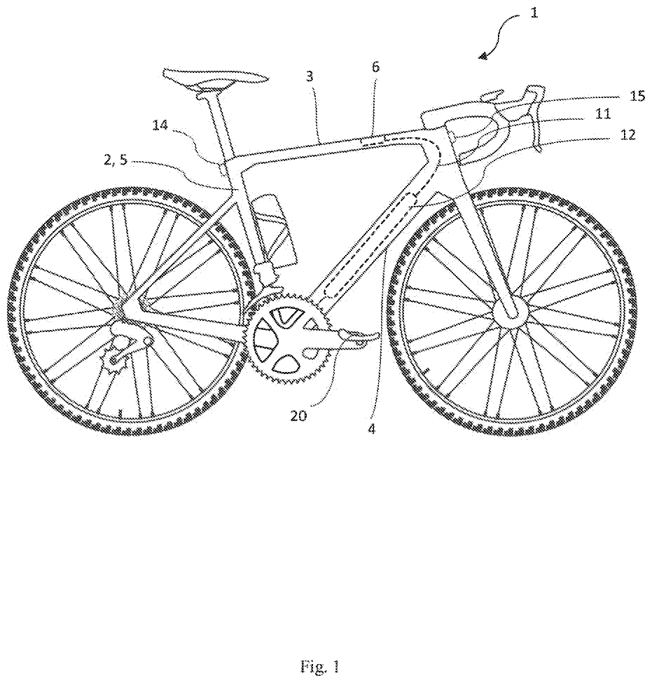

FIG. 1 shows a bicycle 1 according to the invention. In the embodiment shown the bicycle 1 is a human powered bicycle with electric motor assist, otherwise known as pedelec. The invention however applies to other types of bicycles. The bicycle 1 comprises a frame 2 for supporting a front and rear wheel. The frame 2 is made out of a plurality of tubular sections which are welded together. In particular, the frame 2 comprises a top tube 3, a down tube 4 and a seat tube 5.

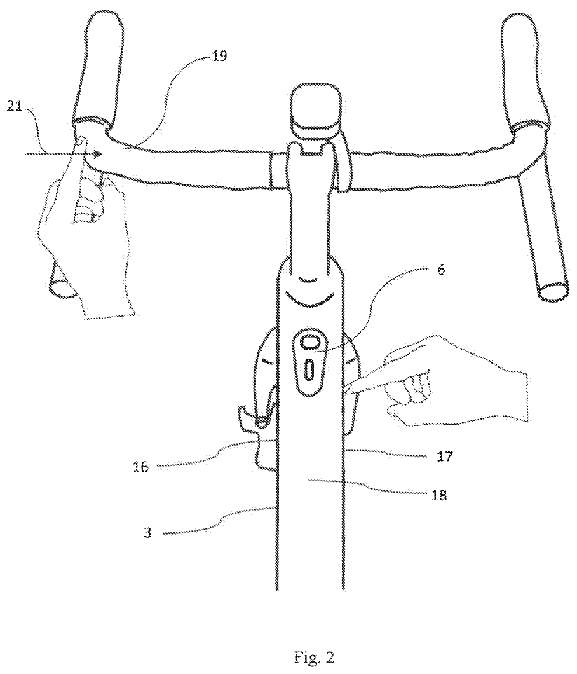

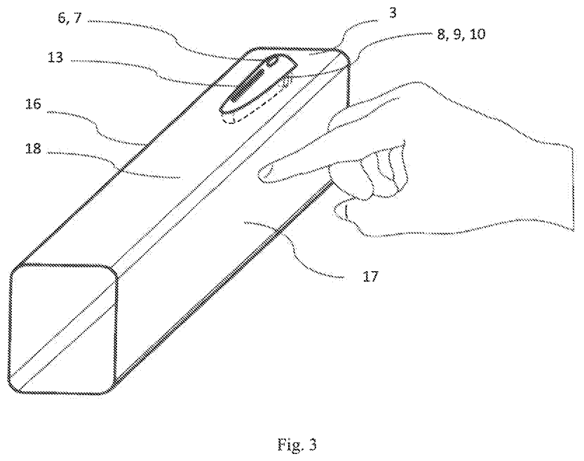

A control unit 6 is arranged at least partly in one of the tubular sections 3, 4, 5. As can be seen in FIGS. 2 and 3 part of the control unit 6 can protrude through an opening in the tubular section 3, 4, 5. In the preferred embodiment shown in FIGS. 1 and 2 the control unit 6 is arranged at least partly in the top tube 3 of the bicycle. The control unit 6 can therefore be easily connected via a cable 11 in the bicycle frame 2 to a battery 12 in the down tube 4. The control unit 6 can control the assist power provided by an electric motor. The control unit 6 can further include a display 13 for displaying information to the rider. The display can be for example an LED display for displaying the charge level of the battery 12.

The control unit 6 comprises a housing 7, which is rigidly attached to the tubular section 3, 4, 5, such that motion of the tubular section 3, 4, 5 in the area of the control unit results in a movement of the control unit 6. At least one accelerometer 8 is arranged within the control unit housing 7 and arranged to sense an acceleration of the tubular section 3, 4, 5 containing the control unit 6 in the area of the control unit 6. A memory 9 storing a tap recognition algorithm and a processor 10 for analyzing an output signal of the at least one accelerometer 8 is also contained within the housing 7. The processor 10 uses the tap recognition algorithm to process the signal from the accelerometer(s) 8 in order to determine a tap action from a selection of predetermined tap actions.

By using the accelerometer in the control unit 6 within the bicycle frame, the frame 2 itself can be used as the input device for controlling various aspects of the bicycle. A separate input device with cables connected to a control unit is not required, instead the operator can tap on the bicycle frame in the vicinity of the control unit as shown in FIG. 3, and the acceleration of the control unit 6 and the accelerometer 8 contained therein will be substantially the same as the acceleration of the frame 2 in the vicinity of the control unit 6 due to the rigid attachment of the frame 2 with the control unit housing 7. A separate input device can thus be omitted reducing component costs. The accelerometer(s) 8 in the control unit 6 can be used for other bicycle control purposes which require for speed or orientation information. For example, the at least one accelerometer 8 in the control unit 6 can also be used to provide a speed calculation algorithm stored in the control unit 6 with acceleration data for calculating a speed of the bicycle. By using the frame 2 as the input device, the operator of the bicycle 1 does not need to locate a manual switch and can tap the frame 2 whilst looking at the road ahead.

The tap recognition algorithm can be configured to differentiate between a plurality of different tap actions. The control unit 6 is configured to output a signal for controlling or operating an electrically controlled bicycle component 14, 15 based on the determined tap action. In particular, the tap recognition algorithm can be configured to differentiate between different tap actions such as a tap on the left side 16 of the tubular section 3, 4, 5, and a tap on the right side 17 of the tubular section. A tap on the left side 16 of the frame 2 can be used for example to reduce the assist level of a motor (not shown) provided on the bicycle to assist the pedal power, and a tap on the right side 17 of the frame 2 can be used to increase the assist level of the motor. Alternatively or additionally, the tap algorithm can be configured to differentiate between a tap on top side 18 of the tubular section and a tap on the lateral side 16, 17 (i.e. left or right side) of the tubular section, in particular the top tube 3. A tap on the top side 18 of the frame 2 can therefore be used e.g. to turn a front light 15 or rear light 14 on or off.

Electrically controlled bicycle components which can be controlled by the tap input include for example front or rear light (14, 15), and/or an electric motor assist of the bicycle, wherein the level of motor assist is increased or decreased depending on the determined tap action. The tap action can also be used to block or unblock or otherwise control a suspension of the bicycle.

Other parts of the bicycle, which perform conventional bicycle functions, for example the pedals 20 or the handlebar 19 can also be used as a tap input surface provided that there is a path for transmission of at least part of tap force from the tap input surface to the accelerometer via the bicycle frame 2, resulting in an acceleration of the accelerometer 8. In the case of the handlebar 19 which is pivotally attached to the frame 2, a tap in the lateral direction, indicated by arrow 21 in FIG. 2, would transmit force to the accelerometer 8 through the pivotal attachment of the handlebar 19 and via the frame 2.

The different sides of the frame 2, i.e. the top side 18, left side 16 and right side 17, or the handlebar 19 or a pedal 20 can therefore be used as tapping input surfaces to operate or control a plurality of different electrically controlled bicycle components 14, 15.

A method for controlling or operating an electrically controlled bicycle thus comprises providing a bicycle frame 2 as described above and sensing via the accelerometer 8 an acceleration of the tubular section 3, 4, 5 containing the control unit 6 in the area of the control unit 6, supplying an output signal of the at least one accelerometer 8 to a processor 10, and using a tap recognition algorithm to determine a tap action and controlling or operating an electrically controlled bicycle component 14, 15 based on the determined tap action.

As described above the method can include using the tap recognition algorithm to differentiate between a plurality of different tap actions from a selection of predetermined tap actions.

The different tap actions can also be in the form of a single or double tap, whereby the singletap action is determined by calculating the gradient of the acceleration between two consecutive acceleration samples, such that if the gradient exceeds a predetermined threshold a single tap action is determined, and wherein a double tap action is determined when two consecutive single tap actions are determined within a predetermined time window. The tap recognition algorithm can be defined by machine learning.

A tap action can be in the form of a specific combination of different taps. For example, a specific combination of taps can be defined from at least two of: a single left tap, a single right tap, a single top tap, a double left tap, a double right tap, a double top tap. This combination is then recognized by the tap recognition algorithm as a specific tap action, which can then be used for controlling an electric component 12, 14, 15 of the bicycle 1. The electrical component can be the battery 12 such that power from the battery can only be supplied to an electric motor after a specific unlocking combination of taps is performed.

1. A bicycle frame for supporting a front wheel and a rear wheel, the bicycle frame comprising: a plurality of tubular sections, a control unit arranged at least partly within one of the tubular sections, wherein the control unit comprises a housing that is rigidly attached to the tubular section, wherein at least one accelerometer is arranged within the housing and arranged to sense an acceleration of the tubular section containing the control unit in an area of the control unit, and further comprising a memory storing a tap recognition algorithm and a processor for analyzing an output signal of the at least one accelerometer using the tap recognition algorithm to determine a tap action.

2. The bicycle frame according to claim 1, wherein the tap recognition algorithm is configured to differentiate between a plurality of different predetermined tap actions.

3. The bicycle frame according to claim 2, wherein:
the tap recognition algorithm is configured to differentiate between a tap on a left side of the tubular section and a tap on a right side of the tubular section, and/or
the tap recognition algorithm is configured to differentiate between a tap on a top side of the tubular section from a tap on a lateral side of the tubular section.

4. The bicycle frame according to claim 1, wherein the tap recognition algorithm is defined by machine learning.

5. The bicycle frame according to claim 1, wherein the control unit is arranged at least partly in a top tube of the plurality of tube sections, wherein the control unit is configured to output a signal for controlling or operating an electrically controlled bicycle component based on the determined tap action.

6. The bicycle frame according to claim 1, wherein the plurality of different tap actions comprises at least a single tap action and a double tap action, whereby the single tap action is determined by calculating a gradient of the acceleration between two consecutive acceleration samples, such that if the gradient exceeds a predetermined threshold a single tap action is determined, and wherein a double tap action is determined when two consecutive single tap actions are determined within a predetermined time window.

7. A bicycle, comprising:
a bicycle frame, the bicycle frame including:
a plurality of tubular sections;
a control unit arranged at least partly within at least one of the tubular sections, wherein the control unit comprises a housing that is rigidly attached to the at least one tubular section,
at least one accelerometer is arranged within the housing and arranged to sense an acceleration of the at least one tubular section containing the control unit in an area of the control unit, and further comprising a memory storing a tap recognition algorithm and a processor for analyzing an output signal of the at least one accelerometer using the tap recognition algorithm to determine a tap action;
a plurality of pedals and a handlebar pivotally attached to the frame,
wherein the tap recognition algorithm is configured to recognize a tap on at least one of the plurality of the pedals and/or the handlebar, such that the at least one pedal and/or the handlebar act as a tap input surface.

8. The bicycle according to claim 7, further comprising at least one of an electric motor, a frontlight and a rear light, wherein the determined tap action controls either the on or off state of the front or rear light or the level of pedal assist provided by the at least one electric motor, wherein in the case of controlling the level of pedal assist, a level of motor assist is increased or decreased depending on the determined tap action.

9. The bicycle according to claim 7 wherein the at least one accelerometer in the control unit provides a speed calculation algorithm stored in the memory of the control unit with acceleration data for calculating a speed of the bicycle.

10. A method for controlling or operating an electrically controlled bicycle component, the method comprising:
providing a bicycle having a bicycle frame, the bicycle frame including a plurality of tubular sections, a control unit arranged at least partly within at least one of the tubular sections, the control unit including a housing that is rigidly attached to the at least one tubular section, a memory and a processor,
sensing via the at least accelerometer an acceleration of the at least one tubular section containing the control unit in an area of the control unit,
supplying an output signal of the at least one accelerometer to the processor which uses a tap recognition algorithm stored in the memory to determine a tap action, and
controlling or operating the electrically controlled bicycle component based on the determined tap action.

11. The method according to claim 10, further comprising using the tap recognition algorithm to differentiate between a plurality of different tap actions.

12. The method according to claim 11, wherein the plurality of different tap actions comprise a single tap action and/or a double tap action, wherein the single tap action is determined by calculating a gradient of the acceleration between two consecutive acceleration samples, such that if the gradient exceeds a predetermined threshold a single tap action is determined, and wherein a double tap action is determined when two consecutive single tap actions are determined within a predetermined time window.

13. The method according to claim 11, wherein:
the tap recognition algorithm is configured to differentiate between a single tap on a left side of the at least one tubular section and a single tap on a right side of the at least one tubular section, and/or
the tap recognition algorithm is configured to differentiate between a single tap on a top side of the at least one tubular section and a single tap on a lateral side of the at least one tubular section.

14. The method according to claim 10, wherein the electrically controlled bicycle component is:
a front or rear light, and/or
an electric motor assist of the bicycle, wherein a level of motor assist is increased or decreased depending on the determined tap action, and/or
a suspension of the bicycle.

15. Use of a bicycle frame or a bicycle handlebar or a bicycle pedal of a bicycle as a tap input surface for controlling or operating an electrically controlled bicycle component, whereby the bicycle frame comprises: a plurality of tubular sections, and a control unit is arranged at least partly in one of the tubular sections, wherein the control unit comprises a housing, which is rigidly attached to the tubular section, wherein at least one accelerometer is arranged within the housing and is capable of sensing an acceleration of the tubular section containing the control unit in an area of the control unit, the acceleration being due to a tap on the tap input surface, and the control unit further comprising a memory storing a tap recognition algorithm and a processor for analyzing an output signal of the at least one accelerometer using the tap recognition algorithm to determine a tap action from a selection of predetermined tap actions.

16. The bicycle according to claim 7, further comprising a front wheel and a rear wheel supported by the bicycle frame.

17. The bicycle according to claim 7, wherein the control unit is arranged at least partly in a top tube of the plurality of tube sections.

18. The bicycle according to claim 7, wherein the tap recognition algorithm is defined by machine learning

19. The bicycle according to claim 7, wherein the tap recognition algorithm is configured to differentiate between a plurality of different predetermined tap actions.

20. The bicycle frame according to claim 2, wherein the plurality of different predetermined tap actions include a tap on different parts of the frame.
